(19) United States
(12) Patent Application Publication
(10) Pub. No.: US 2024/0034540 A1
(43) Pub. Date: Feb. 1, 2024

(54) MOLD INHIBITING FOOD STORAGE CONTAINERS

(71) Applicant: Bradley Anderson, Vancouver, WA (US)

(72) Inventor: Bradley Anderson, Vancouver, WA (US)

(21) Appl. No.: 18/377,566

(22) Filed: Oct. 6, 2023

(51) Int. Cl. B65D 81/20; B65D 43/16; B65D 43/26; B65D 81/26

(52) U.S. Cl. CPC B65D 81/2076; B65D 43/166; B65D 43/26; B65D 81/263; B65D 2543/00194; B65D 2251/1066; B65D 2251/1016

(57) ABSTRACT

Food storage containers including an enclosure, a door, an inert gas chamber, an inert gas, and an inert gas valve. The enclosure contains a food storage environment fluid. The enclosure defines a food storage chamber for a food item with an access opening. The enclosure and the door are complementarily configured to seal the food storage chamber from an external environment when the door is in the closed position. The inert gas chamber is in fluid communication with the food storage chamber. The inert gas valve is configured to selectively allow fluid communication between the inert gas chamber and the food storage chamber. The inert gas valve is disposed between the inert gas chamber and the food storage chamber. The food storage environment fluid is infused with the inert gas from the inert gas chamber at a selected composition when the door is in the closed position.

### BACKGROUND

The present disclosure relates generally to food storage containers. In particular, mold inhibiting food storage containers are described.

Bread boxes and other food storage containers are commonly used to store food items. However, conventional food storage containers are not entirely satisfactory.

For example, existing food storage containers maintain an ambient air environment, which is oxygen-rich and conducive to mold growth. As a result, mold spores tend to establish mold colonies on food items in conventional food storage containers. Further, established mold colonies commonly propagate in the oxygen-rich environment of conventional food storage containers within a matter of days.

Mold colonies can cause food to become unsightly or to spoil. In some instances, being exposed to the mold or ingesting it can cause adverse reactions in people or pets. Thus, inhibiting mold growth on food serves to preserve the food and to avoid adverse reactions to mold.

It would be desirable to have a food storage container that inhibited mold growth on food items stored in the container. Further, it would be beneficial for a food storage container to maintain an environment that was not oxygen-rich like is the case with ambient air. Moreover, it would be advantageous if a food storage container could increase the length of time food could be safely stored.

Thus, there exists a need for food storage containers that improve upon and advance the design of known food storage containers. Examples of new and useful food storage containers relevant to the needs existing in the field are discussed below.

### SUMMARY

The present disclosure is directed to food storage containers including an enclosure, a door, an inert gas chamber, an inert gas, and an inert gas valve. The enclosure contains a food storage environment fluid. The enclosure defines a food storage chamber for a food item with an access opening. The enclosure and the door are complementarily configured to seal the food storage chamber from an external environment when the door is in the closed position. The inert gas chamber is in fluid communication with the food storage chamber. The inert gas valve is configured to selectively allow fluid communication between the inert gas chamber and the food storage chamber. The inert gas valve is disposed between the inert gas chamber and the food storage chamber. The food storage environment fluid is infused with the inert gas from the inert gas chamber at a selected composition when the door is in the closed position.

In some examples, a handle pivotally connects to the door. When the handle is in a release position, the door is free to move between a closed position and a open position. When the handle is in a secure position, the door is restricted to the closed position.

This document describes certain examples where a handle sensor is configured to detect when the handle moves between the secure position and the release position.

In select embodiments, a pump is configured to selectively pressurize and depressurize the inert gas chamber.

As described below, in particular instances, the food storage environment fluid is drawn into the inert gas chamber from the food storage chamber when the handle sensor detects that the handle moves from the secure position to the release position.

In some examples, the pump is configured to depressurize the inert gas chamber and the inert gas valve is configured to selectively allow fluid communication between the inert gas chamber and the food storage chamber when the handle sensor detects that the handle moves from the secure position to the release position.

This document describes certain examples where the pump is configured to pressurize the inert gas chamber and the inert gas valve is configured to selectively allow fluid communication between the inert gas chamber and the food storage chamber when the door is in the closed position to infuse the food storage environment fluid with the inert gas.

In select embodiments, an enclosure valve is disposed between the food storage chamber and the external environment. The enclosure valve may be configured to selectively allow fluid communication between the food storage chamber and the external environment.

As described below, in particular instances the enclosure valve is a one-way valve configured to selectively allow fluid communication exclusively from the food storage chamber to the external environment.

In some examples, the enclosure valve is configured to selectively restrict the food storage environment fluid passing through the enclosure valve to the external environment when a fluid sensor detects that the composition of the food storage environment fluid passing through the enclosure valve to the external environment is comprised of 99% or more of the inert gas.

This document describes certain examples where the pump is configured to selectively stop pressurizing the inert gas chamber when the fluid sensor detects that the composition of the food storage environment fluid passing through the enclosure valve to the external environment is comprised of 99% or more of the inert gas.

In select embodiments, the fluid sensor is further configured to detect the composition of oxygen in the food storage environment fluid passing through the enclosure valve to the external environment.

As described below, in particular instances the fluid sensor is configured to detect the inert gas composition of the inert gas in the food storage environment fluid passing through the enclosure valve to the external environment.

In some examples, the inert gas is argon.

This document describes certain examples where the selected composition of the inert gas in the food storage environment fluid is effective to inhibit mold forming on food in the food storage chamber.

In select embodiments, the food item stored in the food storage chamber is bread.

As described below, in particular instances the inert gas valve is a two-way valve configured to selectively allow fluid communication from the inert gas chamber to the food storage chamber and from the food storage chamber to the inert gas chamber.

### BRIEF DESCRIPTION OF THE DRAWINGS

FIG. 1 is a schematic view of a food storage container.

FIG. 2 is a perspective view of the food storage container depicted in FIG. 1 with a door in a closed position.

FIG. 3 is a front elevation view of the food storage container depicted in FIG. 1 with the door in the closed position and a handle in a secure position.

FIG. 4 is a front elevation view of the food storage container depicted in FIG. 1 with the door in the closed position and a handle in a release position.

FIG. 5 is a front elevation view of the food storage container depicted in FIG. 1 with the door in an open position and a loaf of bread inside the food storage container.

FIG. 6 is a rear elevation view of the food storage container depicted in FIG. 1 depicting a vent to an external environment.

### DETAILED DESCRIPTION

The disclosed food storage containers will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various food storage containers are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

### Definitions

The following definitions apply herein, unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional elements or method steps not expressly recited.

Terms such as “first”, “second”, and “third” are used to distinguish or identify various members of a group, or the like, and are not intended to denote a serial, chronological, or numerical limitation.

“Coupled” means connected, either permanently or releasably, whether directly or indirectly through intervening components.

“Communicatively coupled” means that an electronic device exchanges information with another electronic device, either wirelessly or with a wire-based connector, whether directly or indirectly through a communication network.

“Controllably coupled” means that an electronic device controls operation of another electronic device.

Mold Inhibiting Food Storage Containers

With reference to the figures, mold inhibiting food storage containers will now be described. The food storage containers discussed herein function to store food items while inhibiting mold growth on the food items.

The reader will appreciate from the figures and description below that the presently disclosed food storage containers address many of the shortcomings of conventional food storage containers. For example, the novel food storage containers described herein inhibit mold growth on food items stored within them in contrast to conventional food storage containers that allow mold to readily grow on food items. Further, the novel food storage containers beneficially maintain an environment that is not oxygen-rich like is the case with the ambient air environments maintained by conventional food storage containers. Moreover, the novel food storage containers advantageously increase the length of time food can be safely stored compared to conventional food storage containers.

Contextual Details

Ancillary features relevant to the food storage containers described herein will first be described to provide context and to aid the discussion of the food storage containers.

Food Items

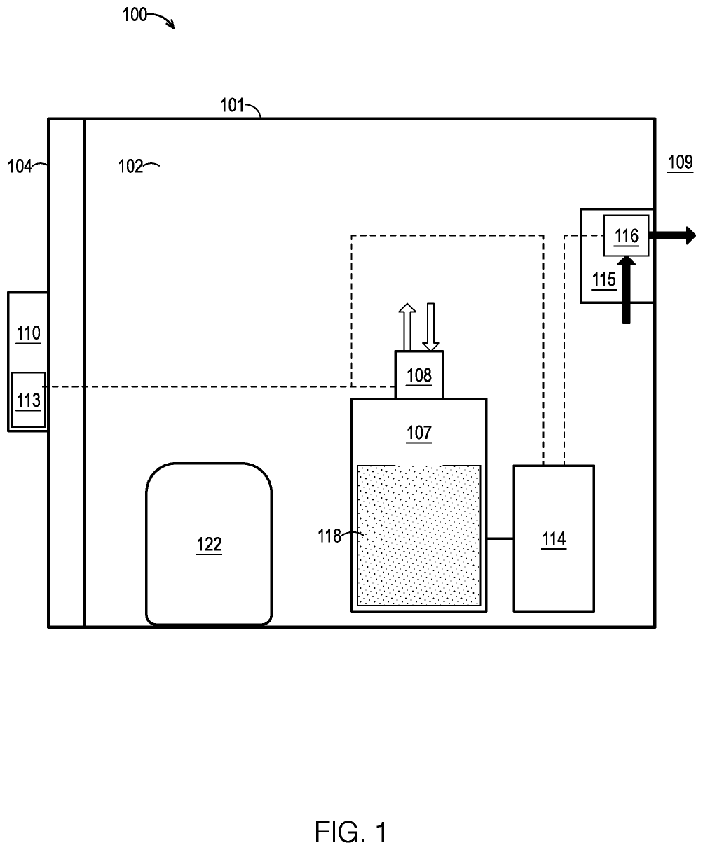

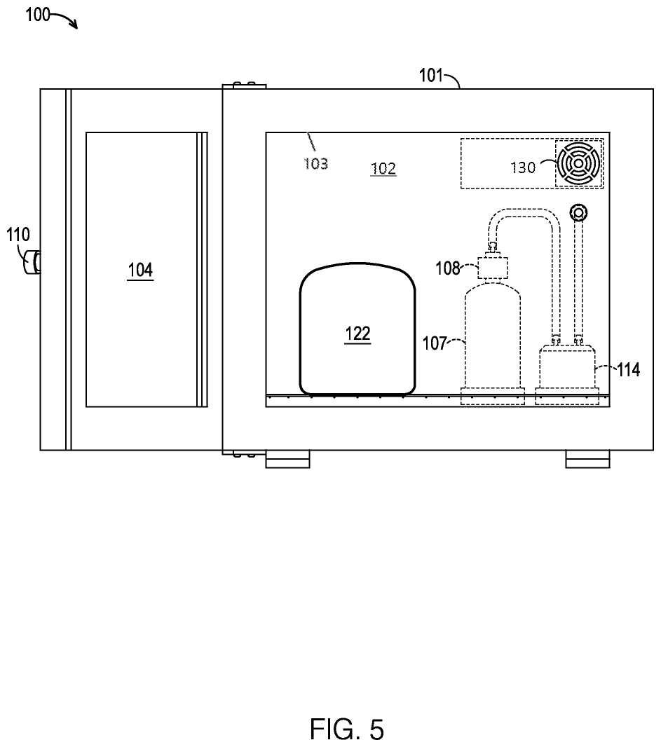

The food storage containers described in this document are used to store food items. One example of a suitable food item, food item 122, is shown in the figures. As shown in FIGS. 1 and 5, food item 122 stored in food storage chamber 102 is bread.

However, the food item may be any currently known or later developed type of food. A wide variety of food items could be used in place of the food item shown in the figures, such as fruit, vegetables, meat, dairy products, and processed foods.

The number of food items in the food storage container may be selected to meet the needs of a given application. The reader should appreciate that the number of food items may be different in other examples than is shown in the figures. For instance, some food storage container examples include additional food items than described in the present example.

Food Storage Container Embodiment One

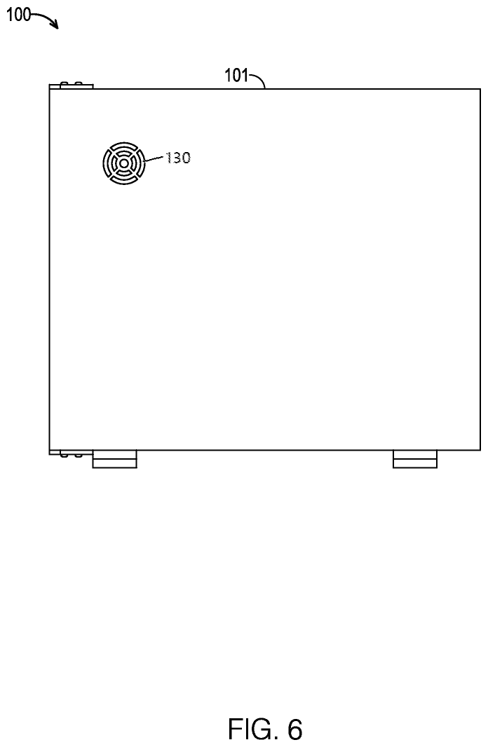

With reference to FIGS. 1-6, a food storage container 100 will now be described as a first example of a food storage container. The role of food storage container 100 is to store food items in a manner that inhibits mold growth on the food items.

The reader can see in FIGS. 1-6 that food storage container 100 includes an inert gas 118, an enclosure 101, a door 104, an inert gas chamber 107, an inert gas valve 108, a handle 110, a handle sensor 113, a pump 114, an enclosure valve 115, a fluid sensor 116, and a vent 130. In other examples, the food storage container includes fewer components than depicted in the figures. In certain examples, the food storage container includes additional or alternative components than depicted in the figures.

The size and shape of the food storage container may be varied as needed for a given application. In some examples, the food storage container is larger or smaller relative to the other components than depicted in the figures.

Enclosure

The role of enclosure 101 is to enclose a food storage environment fluid and to contain food items. Enclosure 101 also functions to support other components of food storage container 100, including door 104, inert gas chamber 107, inert gas valve 107, pump 114, and enclosure valve 115.

As depicted in FIGS. 1 and 5, enclosure 101 defines a food storage chamber 102 and an access opening 103. The reader can see in FIGS. 1 and 5 that food item 122 is disposed within food storage chamber 102.

Enclosure 101 contains a food storage environment fluid, which is described in more detail in the section below. With reference to FIGS. 1-5, enclosure 101 and door 104 are complementarily configured to selectively seal food storage chamber 102 and isolate the food storage environment fluid from an external environment 109 outside food storage chamber 102. In particular, enclosure 101 and door 104 selectively seal food storage chamber 102 when door 104 is in the closed position.

Access opening 103 functions to allow food items to be placed within and removed from food storage chamber 102. The reader can see in FIGS. 1-4 that access opening 103 is covered by door 104 when door 104 is in a closed position. As shown in FIG. 5, access opening 103 is unobstructed by door 104 when door 104 is in an open position. When door 104 is in the open position, one can access food storage chamber 102 through access opening 103.

Food Storage Environment Fluid

The food storage environment fluid, when selectively infused with inert gas 118, functions to inhibit mold forming on food item 122. The food storage environment fluid is infused with inert gas 118 at a selected composition of inert gas 118 effective to inhibit mold forming on food in food storage chamber 102. Details of inert gas 118 are discussed in the inert gas section below.

The food storage environment fluid is selectively infused with inert gas 118 from inert gas chamber 107. In particular, the food storage environment fluid is infused with inert gas 118 from inert gas chamber 107 when door 104 is in the closed position and handle 110 is in the secure position. The selected composition of inert gas 118 in the food storage environment fluid is maintained when door 104 is in the closed position.

In the present example, the food storage environment fluid is selectively drawn into inert gas chamber 107 from food storage chamber 102 to retain inert gas 118 within food storage container 100. Drawing inert gas 118 into inert gas chamber 107 avoids inert gas 118 escaping out access opening 103 when door 104 is open, which would occur if inert gas 118 was disposed in food storage chamber 102. In the present example, the food storage environment fluid is selectively drawn into inert gas chamber 107 from food storage chamber 102 when handle sensor 113 detects that handle 110 moves from a secure position to a release position.

In the present example, the food storage environment fluid is composed of air mixed with argon. However, the food storage environment fluid may be composed of any currently known or later developed mixture suitable for food preservation applications. Suitable mixtures include air mixed with inert gases, such as argon or other noble gases, nitrogen mixed with inert gases, a mixture consisting exclusively of inert gases, or a pure inert gas composition.

Inert Gas

Inert gas 118 functions to inhibit mold forming on food item 122 in food storage chamber 102. The selected composition of inert gas 118 in the food storage environment fluid is effective to inhibit mold forming on food in food storage chamber 102.

In the present example, inert gas 118 is composed of argon. However, the inert gas may be composed of any known or later developed elements or molecules suitable for food storage applications. Suitable elements include noble gases, including argon, helium, neon, xenon, radon, and krypton.

Door

Door 104 serves to selectively cover access opening 103. The reader can see in FIGS. 1, 2, and 5 that door 104 is pivotally coupled to enclosure 101 proximate access opening 103.

As shown in FIGS. 1-5, door 104 is configured to selectively move relative to enclosure 101 between an open position and a closed position. As depicted in FIGS. 24, door 104 is restricted to the closed position when handle 110 is in the secure position. Door 104 is free to move between the closed position and the open position when handle 110 is in the release position.

Inert Gas Chamber

Inert gas chamber 107 serves to contain inert gas 118 and the food storage environment fluid. As shown in FIGS. 1 and 5, inert gas chamber 107 is in fluid communication with food storage chamber 102 subject to inert gas valve 108.

The inert gas chamber may be any currently known or later developed type of gas chamber. Various gas chamber types exist and could be used in place of the inert gas chamber shown in the figures. In addition to the types of gas chambers existing currently, it is contemplated that the food storage containers described herein could incorporate new types of gas chambers developed in the future.

The number of inert gas chambers in the food storage container may be selected to meet the needs of a given application. The reader should appreciate that the number of inert gas chambers may be different in other examples than is shown in the figures. For instance, some food storage container examples include additional or fewer inert gas chambers than described in the present example.

The size and shape of the inert gas chamber may be vaned as needed for a given application. In some examples, the inert gas chamber is larger or smaller relative to the other components than depicted in the figures.

Inert Gas Valve

The reader can see in FIGS. 1 and 5 that inert gas valve 108 is configured to selectively allow fluid communication between inert gas chamber 107 and food storage chamber 102. As depicted in FIGS. 1 and 5, inert gas valve 108 is disposed between inert gas chamber 107 and food storage chamber 102. With reference to FIG. 1, inert gas valve 108 is a two-way valve configured to selectively allow fluid communication from inert gas chamber 107 to food storage chamber 102 and from food storage chamber 102 to inert gas chamber 107.

In the present example, inert gas valve 108 is configured to selectively allow the food storage environment fluid to be drawn into inert gas chamber 107 from food storage chamber 102 based on the position of handle 110. In particular, inert gas valve 108 is configured to selectively allow the food storage environment fluid to be drawn into inert gas chamber 107 when handle sensor 113 detects that handle 110 moves from the secure position to the release position. In other examples, other criteria or triggers are used to determine when the inert gas valve allows the food storage environment fluid to be drawn into the inert gas chamber.

The inert gas valve may be any currently known or later developed type of valve. Various valve types exist and could be used in place of the inert gas valve shown in the figures. In addition to the types of valves existing currently, it is contemplated that the food storage containers described herein could incorporate new types of valves developed in the future.

Handle

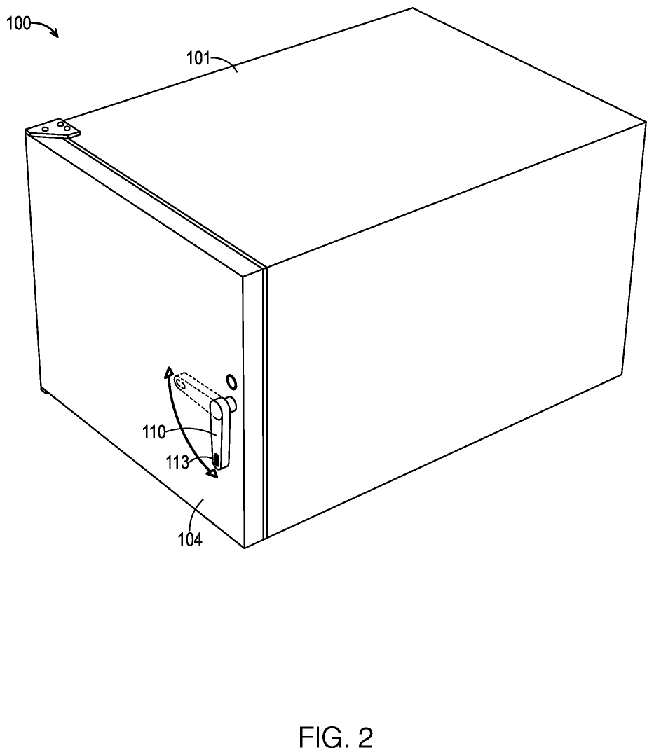

Handle 110 serves to selectively lock and unlock door 104. As depicted in FIGS. 2-5, handle 110 pivotally connects to door 104.

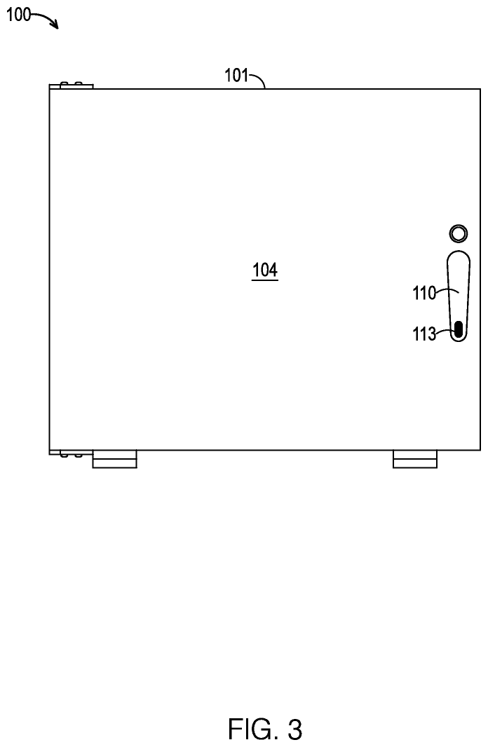

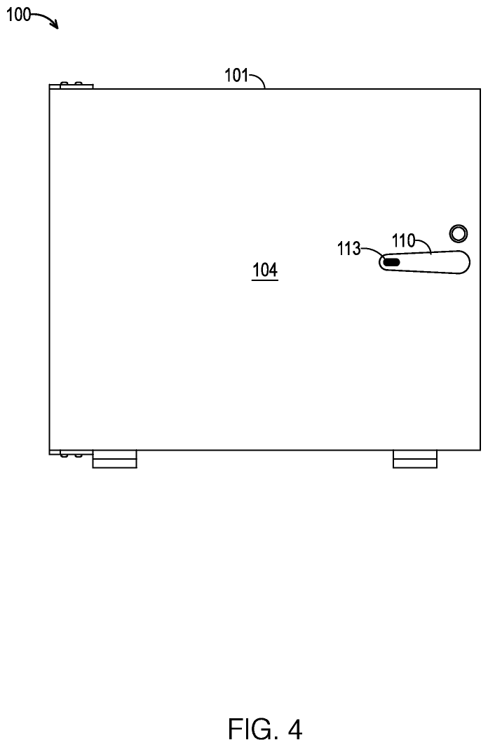

With reference to FIGS. 2-4, handle 110 is configured to move between a secure position shown in FIG. 3 and a release position shown in FIG. 4. As shown in FIGS. 2 and 3, when handle 110 is in the secure position, door 104 is restricted to the closed position. The reader can see in FIG. 5 that when handle 110 is in the release position, door 104 is free to move between the closed position and the open position.

In the present example, handle 110 establishes when inert gas valve 108 selectively allows the food storage environment fluid to be drawn into inert gas chamber 107 from food storage chamber 102. In particular, inert gas valve 108 is configured to selectively allow the food storage environment fluid to be drawn into inert gas chamber 107 when handle sensor 113 detects that handle 110 moves from the secure position to the release position.

The handle may be any currently known or later developed type of handle. Various handle types exist and could be used in place of the handle shown in the figures. In addition to the types of handles existing currently, it is contemplated that the food storage containers described herein could incorporate new types of handles developed in the future.

The size and shape of the handle may be varied as needed for a given application. In some examples, the handle is larger or smaller relative to the other components than depicted in the figures.

Handle Sensor

The role of handle sensor 113 is to detect the position of handle 110. In particular, as shown in FIGS. 2-4, handle sensor 113 is configured to detect when handle 110 moves between the secure position and the release position.

As indicated with dashed lines in FIG. 1, handle sensor 113 is controllably coupled to inert gas valve 108. In the present example, handle sensor 113 serves as the trigger for when inert gas valve 108 selectively allows the food storage environment fluid to be drawn into inert gas chamber 107. In particular, inert gas valve 108 is configured to selectively allow the food storage environment fluid to be drawn into inert gas chamber 107 when handle sensor 113 detects that handle 110 moves from the secure position to the release position.

As further indicated with dashed lines in FIG. 1, handle sensor 113 is controllably coupled to pump 114. Pump 114 selectively depressurizes inert gas chamber 107 to draw the food storage environment fluid infused with inert gas 118 into inert gas chamber 107 when handle sensor 113 detects that handle 110 is in the release position.

The handle sensor may be any currently known or later developed type of sensor adapted to detect the position of a handle. Various sensor types exist and could be used in place of the handle sensor shown in the figures. In addition to the types of sensors existing currently, it is contemplated that the food storage containers described herein could incorporate new types of sensors developed in the future.

Pump

Pump 114 is configured to selectively pressurize and depressurize inert gas chamber 107. When selectively depressurizing inert gas chamber 107, pump 114 draws the food storage environment fluid infused with inert gas 118 into inert gas chamber 107 through inert gas valve 108. When selectively pressurizing inert gas chamber 107, pump 114 moves the food storage environment fluid infused with inert gas 118 into food storage chamber 102 through inert gas valve 108.

Pump 114 selectively pressurizing inert gas chamber 107 also pressurizes food storage chamber 102 if enclosure valve 115 is selectively closed. If enclosure valve 115 is selectively open, pump 114 selectively pressurizing inert gas chamber 107 expels the food storage environment fluid out of a vent 130 through enclosure valve 115.

In the present example, pump 114 and fluid sensor 116 cooperate to selectively open enclosure valve 115 and to pressurize inert gas chamber 107 to force fluid out of vent 130. In particular, pump 114 and fluid sensor 116 cooperate to expel fluid out of vent 130 until fluid sensor 116 detects that the exiting fluid is at least the selected composition, which may be at least 99% inert gas 118. When fluid sensor 116 detects that the food storage environment fluid exiting food storage chamber 102 is at least the selected composition, enclosure valve 115 selectively closes and pump 114 stops pressurizing inert gas chamber 107.

As described above, pump 114 is configured to depressurize inert gas chamber 107 and inert gas valve 108 is configured to selectively allow fluid communication between inert gas chamber 107 and food storage chamber 102 when handle sensor 113 detects that handle 110 moves from the secure position to the release position. With reference to FIG. 1, pump 114 is configured to pressurize inert gas chamber 107 and inert gas valve 108 is configured to selectively allow fluid communication between inert gas chamber 107 and food storage chamber 102 when door 104 is in the closed position to infuse the food storage environment fluid with inert gas 118.

The pump may be any currently known or later developed type of pump. Various pump types exist and could be used in place of the pump shown in the figures. In addition to the types of pumps existing currently, it is contemplated that the food storage containers described herein could incorporate new types of pumps developed in the future.

Enclosure Valve

With reference to FIG. 1, enclosure valve 115 is configured to selectively allow fluid communication between food storage chamber 102 and external environment 109. As depicted in FIGS. 1 and 5, enclosure valve 115 is disposed between food storage chamber 102 and external environment 109.

In the present example, as shown in FIG. 1, enclosure valve 115 is a one-way valve. The one-way configuration of enclosure valve 115 means that it is configured to selectively allow fluid communication exclusively from food storage chamber 102 to external environment 109. Expressed another way, enclosure valve 115 restricts fluid from external environment 109 entering food storage chamber 102 through enclosure valve 115. The enclosure valve is not required to be a one-way valve in all examples, however.

Enclosure valve 115 is controllably coupled to fluid sensor 116. In particular, enclosure valve 115 is configured to selectively restrict the food storage environment fluid passing through enclosure valve 115 to external environment 109 when fluid sensor 116 detects that the composition of the food storage environment fluid has at least the selected composition of inert gas 118. The selected composition of inert gas 118 may be 99% inert gas.

The enclosure valve may be any currently known or later developed type of valve. Various valve types exist and could be used in place of the enclosure valve shown in the figures. In addition to the types of valves existing currently, it is contemplated that the food storage containers described herein could incorporate new types of valves developed in the future.

Fluid Sensor

Fluid sensor 116 serves to detect the composition of inert gas 118 in the food storage environment fluid. In particular, fluid sensor 116 is configured to detect the composition of inert gas 118 in the food storage environment fluid passing through enclosure valve 115 to external environment 109. In the present example, fluid sensor 116 is further configured to detect the composition of oxygen in the food storage environment fluid. However, not all fluid sensor examples are configured to detect oxygen concentration in the food storage environment fluid.

The fluid sensor may be any currently known or later developed type of fluid sensor. Various fluid sensor types exist and could be used in place of the fluid sensor shown in the figures. In addition to the types of fluid sensors existing currently, it is contemplated that the food storage containers described herein could incorporate new types of fluid sensors developed in the future.

The number of fluid sensors may be selected to meet the needs of a given application. In some examples, the food storage containers contain more than one fluid sensor. The fluid sensors may be disposed in additional or alternative locations than proximate the enclosure valve.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A food storage container, comprising:
an enclosure defining a food storage chamber for a food item with an access opening and containing a food storage environment fluid:
a door coupled to the enclosure proximate the access opening and configured to selectively move relative to the enclosure between an open position and a closed position;
an inert gas chamber in fluid communication with the food storage chamber;
an inert gas contained within the inert gas chamber; and
an inert gas valve disposed between the inert gas chamber and the food storage chamber;
wherein:
the access opening is unobstructed by the door in the open position to provide access to the food storage chamber through the access opening,
the access opening is covered by the door in the closed position;
the door and the enclosure are complementarily configured to seal the food storage chamber from an external environment outside the food storage chamber when the door is in the closed position;
the inert gas valve is configured to selectively allow fluid communication between the inert gas chamber and the food storage chamber; and
the food storage environment fluid is infused with the inert gas from the inert gas chamber at a selected composition of the inert gas when the door is in the closed position.

2. The food storage container of claim 1, further comprising a handle operatively connected to the door and configured to move between a secure position and a release position, where the door is restricted to the closed position when the handle is in the secure position and the door is free to move between the closed position and the open position when the handle is in the release position.

3. The food storage container of claim 2, further comprising a handle sensor configured to detect when the handle moves between the secure position and the release position.

4. The food storage container of claim 3, further comprising a pump configured to selectively pressurize and depressurize the inert gas chamber.

5. The food storage container of claim 4, wherein the food storage environment fluid is drawn into the inert gas chamber from the food storage chamber when the handle sensor detects that the handle moves from the secure position to the release position.

6. The food storage container of claim 5, wherein the pump is configured to depressurize the inert gas chamber and the inert gas valve is configured to selectively allow fluid communication between the inert gas chamber and the food storage chamber when the handle sensor detects that the handle moves from the secure position to the release position.

7. The food storage container of claim 6, wherein the pump is configured to pressurize the inert gas chamber and the inert gas valve is configured to selectively allow fluid communication between the inert gas chamber and the food storage chamber when the door is in the closed position to infuse the food storage environment fluid with the inert gas.

8. The food storage container of claim 7, further comprising an enclosure valve disposed between the food storage chamber and the external environment and configured to selectively allow fluid communication between the food storage chamber and the external environment.

9. The food storage container of claim 8, wherein the enclosure valve is a one-way valve configured to selectively allow fluid communication exclusively from the food storage chamber to the external environment.

10. The food storage container of claim 9, further comprising a fluid sensor configured to detect the inert gas composition of the inert gas in the food storage environment fluid passing through the enclosure valve to the external environment.

11. The food storage container of claim 10, wherein the enclosure valve is configured to selectively restrict the food storage environment fluid passing through the enclosure valve to the external environment when the fluid sensor detects that the composition of the food storage environment fluid passing through the enclosure valve to the external environment is comprised of 99% or more of the inert gas.

12. The food storage container of claim 11, wherein the pump is configured to selectively stop pressurizing the inert gas chamber when the fluid sensor detects that the composition of the food storage environment fluid passing through the enclosure valve to the external environment is comprised of 99% or more of the inert gas.

13. The food storage container of claim 10, wherein the fluid sensor is further configured to detect the composition of oxygen in the food storage environment fluid passing through the enclosure valve to the external environment.

14. The food storage container of claim 1, wherein the inert gas is argon.

15. The food storage container of claim 1, wherein the selected composition of the inert gas in the food storage environment fluid is effective to inhibit mold forming on food in the food storage chamber.

16. The food storage container of claim 15, wherein the food item stored in the food storage chamber is bread.

17. The food storage container of claim 1, wherein the inert gas valve is a two-way valve configured to selectively allow fluid communication from the inert gas chamber to the food storage chamber and from the food storage chamber to the inert gas chamber.

18. A food storage container, comprising:
an enclosure defining a food storage chamber with an access opening and containing a food storage environment fluid;
a door coupled to the enclosure proximate the access opening and configured to selectively move relative to the enclosure between an open position and a closed position;
an inert gas chamber in fluid communication with the food storage chamber,
an inert gas contained within the inert gas chamber;
an inert gas valve disposed between the inert gas chamber and the food storage chamber;
a pump configured to selectively pressurize and depressurize the inert gas chamber,
an enclosure valve disposed between the food storage chamber and an external environment outside the food storage container and configured to selectively allow fluid communication between the food storage chamber and the external environment;
a fluid sensor downstream of the enclosure valve and configured to detect the composition of the inert gas in the food storage environment fluid passing through the enclosure valve to the external environment;
a handle operatively connected to the door and configured to move between a secure position and a release position; and
a handle sensor configured to detect when the handle moves between the secure position and the release position:
wherein:
the access opening is unobstructed by the door in the open position to provide access to the food storage chamber through the access opening;
the access opening is covered by the door in the closed position;
the door and the enclosure are complementarily configured to seal the food storage chamber from the external environment when the door is in the closed position;
the door is restricted to the closed position when the handle is in the secure position and the door is free to move between the closed position and the open position when the handle is in the release position;
the inert gas valve is configured to selectively allow fluid communication between the inert gas chamber and the food storage chamber; and
the food storage environment fluid is infused with the inert gas from the inert gas chamber at a selected composition of the inert gas effective to inhibit mold forming on food in the food storage chamber when the door is in the closed position and the handle is in the secure position.

19. The food storage container of claim 1, wherein the inert gas is argon.

20. The food storage container of claim 1, wherein:
the pump is configured to depressurize the inert gas chamber and the inert gas valve is configured to selectively allow fluid communication between the inert gas chamber and the food storage chamber when the handle sensor detects that the handle moves from the secure position to the release position;
the pump is configured to pressurize the inert gas chamber and the inert gas valve is configured to selectively allow fluid communication between the inert gas chamber and the food storage chamber when the door is in the closed position and the handle is in the secure position to infuse the food storage environment fluid with the inert gas; and
the enclosure valve is configured to selectively restrict the food storage environment fluid passing through the enclosure valve to the external environment when the fluid sensor detects that the composition of the food storage environment fluid passing through the enclosure valve to the external environment has at least the selected composition of the inert gas.
